(19) United States
(12) Patent Application Publication
(10) Pub. No.: US 2015/0127942 A1
(43) Pub. Date: May 7, 2015

(54) SECURITY KEY DEVICE FOR SECURE CLOUD SERVICE, AND SYSTEM AND METHOD FOR PROVIDING SECURE CLOUD SERVICE

(71) Applicant: SAFERZONE CO., LTD., Daejeon (KR)

(72) Inventors: Dong Yun LEE, Seoul (KR); Chul Su KIM, Daejeon (KR); Jae Sik CHOI, Daejeon (KR); Won Jang SON, Gyeonggi-do (KR)

(73) Assignee: SAFERZONE CO., LTD., Daejeon (KR)

(21) Appl. No.: 14/080,295

(22) Filed: Nov. 14, 2013

(30) Foreign Application Priority Data
Nov. 4, 2013 (KR) 10-2013-0132936

(51) Int. Cl. H04L 29/06

(52) U.S. Cl. CPC H04L 63/0428
USPC 713/168

(57) ABSTRACT

Provided are a security key device for a cloud service, and a system and a method for providing a secure cloud service. The security key device includes: an interface unit detachably connected to a user terminal, and providing an interface with the user terminal; a storage unit storing an encoded user file; and an encoding/decoding transformation supporting controller that, when receiving from the user terminal a file to upload to a cloud server, encodes the file, stores the encoded file in the storage unit, and then transmits the encoded file to the user terminal, and when receiving from the user terminal an encoded file downloaded from the cloud server, stores the encoded file in the storage unit, decodes the encoded file, and transmits the decoded file to the user terminal.

### CROSS REFERENCE

Applicant claims foreign priority under Paris Convention and 35 U.S.C. §119 to Korean Patent Application No. 10-2013-0132936, filed 4 Nov. 2013, with the Korean Intellectual Property Office, where the entire contents are incorporated herein by reference.

### BACKGROUND OF THE INVENTION

1. Field of the Invention

The present invention relates to a security key device for providing a security-improved cloud service, and a system and an operating method using the same, in which an encryption key is managed through a hardware security key device detachably connected to a user terminal, and an encoding engine also encodes/decodes a file in a hardware embedded device and stores the file in a cloud server, thereby improving security.

2. Description of the Prior Art

In recent years, a cloud computing environment has been widely used to efficiently distribute Information Technology (IT) resources and to securely store data. John McCarthy, an American computer scientist, already advocated the concept of cloud computing in the 1960s, and cloud computing has grown at a rapid pace along with an improvement of the communication infrastructure and an increased demand for efficient distribution of resources of the computing environment.

High performance terminals are not necessary for the cloud computing environment, and therefore investment costs at a client level for IT equipment can be reduced and IT resources can be efficiently distributed according to use environments. However, data may be leaked if a server is hacked in the cloud computing, and a user's important data is likely to be leaked by a malicious service provider providing a cloud computing service.

In particular, as the cloud service is vitalized in a mobile environment like a smart phone as well as a PC environment, solving security problems caused by hacking of the cloud server is emerging as an urgent issue.

To this end, KR Patent No. 10-1107056 proposes a method in which, before transmitting a synchronized file to a cloud server, a client terminal encodes the corresponding file in advance and transmits the encoded file to the cloud server, and after receiving an encoded file from the cloud server, the client terminal decodes the received encoded file.

Some of such conventional products employ a scheme in which a window agency application program directly manages an encryption key for encryption using a software algorithm module and a scheme in which a file is encrypted by software by using an encryption key stored in a hardware device.

As described above, the encoding is performed through the software in the conventional file encoding scheme for improving security in the cloud service, so that the encryption key is managed through a window program and is exposed to a monitor program of hackers, thereby causing problems in security.

### SUMMARY OF THE INVENTION

Accordingly, the present invention has been made to solve the above-mentioned problems occurring in the prior art, and an aspect of the present invention is to provide a security key device for providing a security-improved cloud service, and a system and an operating method using the same, in which a security key device connected to a user terminal stores an encryption key and encodes a file, thereby preventing leakage of a security key due to hacking, and only when the security key device is connected to the user terminal, a cloud file can be encoded/decoded so that synchronization can be made, thereby further improving security.

In accordance with an aspect of the present invention, there is provided a security key device for a secure cloud service, comprising: an interface unit detachably connected to a user terminal, and providing an interface with the user terminal; a storage unit storing an encoded user file; and an encoding/decoding transformation supporting controller that, when receiving from the user terminal a file to upload to a cloud server, encodes the file, stores the encoded file in the storage unit, and then transmits the encoded file to the user terminal, and when receiving from the user terminal an encoded file downloaded from the cloud server, stores the encoded file in the storage unit, decodes the encoded file, and transmits the decoded file to the user terminal.

Preferably, the storage unit is distinguished into an ordinary data storage area and an encoded file storage area.

Preferably, the security key device further comprises: a security authentication chip comprising at least one of password information, a user's fingerprint information, and an OTP value for user authentication, wherein the encoding/decoding transformation supporting controller operates only when the user authentication is performed through the security authentication chip.

In accordance with another aspect of the present invention, there is provided a system for providing a secure cloud service which shares a user's file through a cloud service, the system comprising: a cloud server providing the cloud service for sharing the user's file; a user terminal in which an agent providing the secure cloud service is installed; and a security key device that operates while being detachably connected to the user terminal, when receiving from the agent a file to upload to the cloud server, encodes the file to transmit the encoded file to the agent, and when receiving from the agent an encoded file downloaded from the cloud server, decodes the encoded file to transmit the decoded file to the user terminal.

Preferably, the agent generates a secure synchronous folder for secure cloud synchronization, transmits a specific file within the user terminal to the security key device when the specific file is transferred to the secure synchronous folder, and when receiving an encoded file from the security key device, transmits the encoded file to the cloud server.

Preferably, the agent generates the secure synchronous folder as a subfolder of a synchronous folder for cloud synchronization, monitors file input/output of the secure synchronous folder in real time, and when a file is transferred to the secure synchronous folder, encodes the file through the security key device to store the encoded file in the secure synchronous folder.

In accordance with further another aspect of the present invention, there is provided a method of providing a cloud service by an agent installed in a user terminal, the method comprising: detecting a connection of a security key device; performing user authentication processing when the connection of the security key device is detected; transmitting a specific file within the user terminal to the security key device when the specific file is transferred to a cloud encoding synchronous folder; storing an encoded file in the cloud encoding synchronous folder when the encoded file is received from the security key device; and transmitting the encoded file stored in the cloud encoding synchronous folder to a cloud server through cloud synchronization.

Preferably, the method further comprises: transmitting an encoded file to the security key device when receiving the encoded file from the cloud server; receiving a decoded file from the security key device; and storing the decoded file in the cloud encoding synchronous folder.

Preferably, the method further comprises releasing automatic encoding and deleting a decoded temporary file, when a disconnection of the security key device is detected.

Preferably, the agent generates a secure synchronous folder as a subfolder of the cloud encoding synchronous folder, and performs encoding through the security key device only for a file transferred to the secure synchronous folder.

As described above, in accordance with the present invention, important data of an individual and an enterprise cannot be opened even when a cloud server is hacked, and encoding/decoding are performed in a hardware encoding accelerator so that an encryption key can be prevented from being leaked even when a personal computer is hacked, thereby remarkably improving security as compared with the related art.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates configurations of a system for providing a secure cloud service according to an embodiment of the present invention;

FIG. 2 is a block diagram illustrating detailed configurations of a security key device of FIG. 1;

FIG. 3 is a flowchart illustrating a preliminary process for use of a security key device in a PC environment;

FIG. 4 is a flowchart illustrating a process of encoding a file by using a security key device and transmitting the encoded file to a cloud server in a PC environment;

FIG. 5 is a flowchart illustrating a process of opening a file by using a cloud service in a mobile environment;

FIG. 6 illustrates a process of encoding a file in a security key device during a file upload; and

FIG. 7 illustrates a process of decoding a file in a security key device during a file download.

### DETAILED DESCRIPTION OF THE INVENTION

The present invention may be embodied in many different forms without departing from the spirit and significant characteristics of the invention. Therefore, the embodiments of the present invention are disclosed only for illustrative purposes and should not be construed as limiting the present invention.

It will be understood that, although the terms first, second, etc. may be used herein to describe various elements, these elements should not be limited by these terms.

These terms are only used to distinguish one element, from another element. For instance, a first element discussed below could be termed a second element without departing from the teachings of the present invention. Similarly, the second element could also be termed the first element.

It will be understood that when an element is referred to as being “coupled” or “connected” to another element, it can be directly coupled or connected to the other element or intervening elements may be present therebetween.

In contrast, it should be understood that when an element is referred to as being “directly coupled” or “directly connected” to another element, there are no intervening elements present.

The terminology used herein is for the purpose of describing particular embodiments only and is not intended to be limiting. As used herein, the singular forms “a,” “an” and “the” are intended to include the plural forms as well, unless the context clearly indicates otherwise.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which this invention belongs.

It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, preferred embodiments of the present invention will be described in detail with reference to the attached drawings. The same reference numerals will be used throughout the different drawings to designate the same or similar components, and the repetition of the same explanation for these components will be skipped.

If in the specification, detailed descriptions of well-known functions or configurations would unnecessarily obscure the gist of the present invention, the detailed descriptions will be omitted.

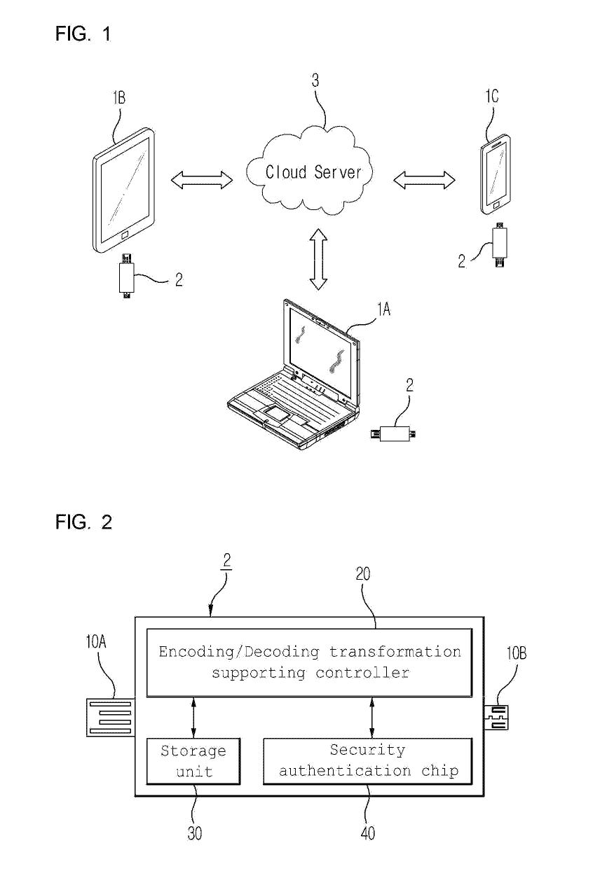

FIG. 1 illustrates configurations of a system for providing a secure cloud service according to an embodiment of the present invention, and FIG. 2 is a block diagram illustrating detailed configurations of a security key device of FIG. 1.

As described in FIG. 1, the system for providing the secure cloud service according to the present invention includes a user terminal 1, a security key device 2, and a cloud server 3.

The user terminal 1 is a device that stores user files, and includes various terminals, such as a personal computer (PC), a notebook computer, a tablet PC, a smart phone, and the like, which have a function of file storage, a function of displaying, and an internet-connected communication environment. In FIG. 1, reference numeral 1A denotes a Personal Computer (PC), reference numeral 1B denotes a tablet PC, and reference numeral 1C denotes a smart phone. An agent is installed in the user terminal 1, the agent providing the secure cloud service according to the present invention. As will be described below, when a user desires to encode a file and to store the encoded file in the cloud server 3, the agent detects a connection of the security key device 2 and allows the security key device 2 to start a file encoding operation only while the security key device 2 is connected to the user terminal 1, thereby improving a security.

The security key device 2 is detachably connected to the user terminal 1, and operates while being connected to the user terminal 1. During a file upload, the security key device 2 encodes a file received from the agent, and transmits the encoded file to the agent. During a file download, the security key 2 receives, from the agent, an encoded file downloaded from the cloud server 3, decodes the encoded file, and transmits the decoded file to the agent.

The cloud server 3 is a device that provides a cloud service for sharing user files. The cloud server 3 stores therein user content such as media files including a movie, a photo, music, and the like, a document, and an address list, and when receiving a request from user terminals including a user PC, a smart phone, and a smart Television (TV), allows the user terminals to download and use the content stored in the server. The domestic cloud services are a NAVER N-DRIVE service, a KT U-cloud service, and a DAUM cloud service, and foreign cloud services are a DROPBOX service, a BOX service, a SUGARSYNC service, a GOOGLE DRIVE service, a SKY DRIVE service, and the like.

FIG. 2 illustrates detailed configurations of the security key device 2. As illustrated in FIG. 2, the security key device 2 includes interface units 10A and 10B, an encoding/decoding transformation supporting controller 20, a storage unit 30, and a security authentication chip 40.

The interface units 10A and 10B are connectors for an electrical connection with the user terminal 1. While a Universal Serial Bus (USB) connector 10A and a micro-USB connector 10B are illustrated as an example of the interface unit in FIG. 2, various interface devices other than the USB connector 10A and the micro-USB connector 10B may be used as the interface unit.

The encoding/decoding transformation supporting controller 20 encodes/decodes a file through an encryption key and an encoding/decoding engine block which are stored therein, and performs a control operation for a data backup when the security key device 2 of the present invention is to be used as a backup memory. Further, the encoding/decoding transformation controller 20 performs a user authentication operation through the security authentication chip 40 when the security key device 2 is connected to the user terminal 1, and performs an encoding operation only when the user is completely authenticated.

The storage unit 30 stores user data, and is divided into several storage areas. Some areas of the storage unit 30 may be used as an ordinary storage area, and the remaining areas may be used for storing encoded files. The storage unit 30 includes a flash memory used as an ordinary USB memory, and various storage mediums.

The security authentication chip 40 is a chip that performs a user authentication operation to provide a security function when the security key device 2 is connected to the user terminal 1, and may store, as a user authentication means, at least one of password information, user fingerprint information, and a One Time Password (OTP) generating module that generates an OTP value.

The password information is a personal identification number set in advance by a user, and is information distinct from the encryption key. Further, a fingerprint recognition apparatus should be installed inside or outside the security key device 2 for user authentication through a user's fingerprint information.

The OTP generating module generates an OTP value by using an arbitrary random number and an increased value or time as an input value of an encryption algorithm, and transmits the generated OTP value to an authentication server for user authentication in the authentication server.

Through the multiple authentication processes, a security performance of the security key device can be improved.

Although the security performance of the security key device is improved through the multiple authentication processes as described above, a user cannot open the encoded files uploaded to the cloud server 3 when the security key device 2 is lost. Accordingly, for users and coworkers anxious about this point, measures for the loss may be prepared through providing a plurality of security key devices having an identical encryption key to enterprises and organizations using two or more security key devices.

Further, the security key devices may be managed to interwork with a separate agency server, for managing a history of a file on which several users collaborate. That is, a plurality of security key devices for coworkers may use one identical encryption key, and identification information for differentiating the respective devices may be allocated to the security key devices, thereby making it possible to manage a history of which user has most recently modified the file on which the users collaborate, and when the file has been copied.

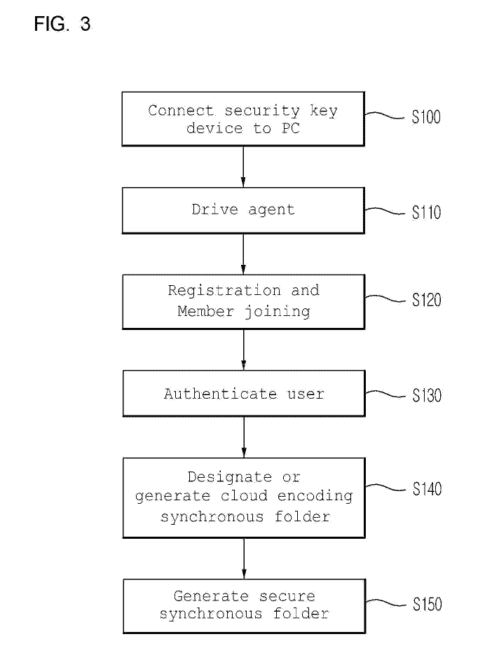

FIG. 3 is a flowchart illustrating a preliminary process for use of a security key device in a PC environment.

When a security key device 2 is connected to a user PC in step S100, an agent loaded in the user PC is driven in step S110. The agent provides a secure cloud service by interworking with the security key device 2. The agent is a program designed to transmit an encoding target file to the security key device 2 when the encoding target file is recognized during cloud synchronization such that the file is encoded in a hardware form, to decode, through the security key device 2, an encoded file downloaded from a cloud server 3, and to perform an automatic encoding operation and an automatic encoding release operation according to a connection of the security key device 2.

When the agent is driven, a user is led to connect with a home page of a manufacturing company of the security key device 2, and to make a user registration and sign up for a membership at the corresponding homepage, in step S120, and then user authentication is performed, in step S130. As described above, the user authentication may be performed through various ways such as a password, fingerprint information, an OTP, and the like.

Thereafter, the agent leads the user to designate or generate a cloud encoding synchronous folder to synchronize with the cloud server 3, in step S140. The cloud encoding synchronous folder may be transmitted to the cloud server 3 after all files stored in the corresponding folder are encoded.

Alternatively, the cloud encoding synchronous folder may also be distinguished into an ordinary synchronous folder for transmitting files to the cloud server 3 without encoding, and a secure synchronous folder for uploading files to the cloud server 3, with the files encoded. In this case, the agent may generate the secure synchronous folder as a subfolder of the cloud encoding synchronous folder, and may perform a secure cloud service operation only for the files stored in the secure synchronous folder, in step S150.

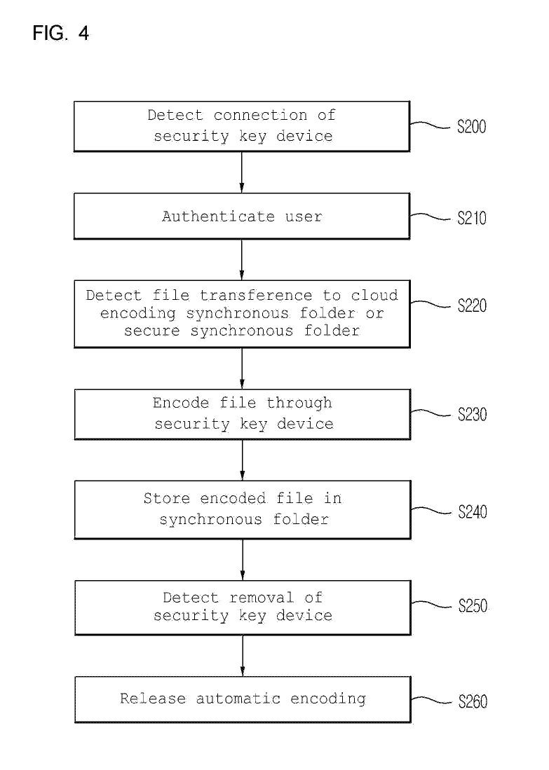

FIG. 4 is a flowchart illustrating a process of encoding a file by using a security key device and transmitting the encoded file to a cloud server in a PC environment.

An agent loaded in a user PC detects in step S200 whether a security key device 2 is connected to the user PC, and in step S210, performs a user authentication operation when the connection of the security key device 2 is detected.

As described above with reference to FIG. 3, in step S220, the agent detects file transference to a cloud encoding synchronous folder or a secure synchronous folder according to an encoding target range of a synchronization target file. In step S230, when a specific file is transferred to the corresponding folder, the agent transmits the corresponding file to the security key device 2 such that the corresponding file is encoded. That is, the agent detects whether a file is transferred into the cloud encoding synchronous folder, when an encoding target is the entire cloud encoding synchronous folder, and detects whether a file is transferred into the secure synchronous folder, when an encoding target is limited to the secure synchronous folder.

In step S240, when an encoded file is received from the security key device 2, the agent stores the received encoded file in the corresponding folder. The encoded file is stored in the cloud encoding synchronous folder or the subordinate secure synchronous folder according to the encoding target range, and in each case, the file stored in the corresponding folder is transmitted to the cloud server 3 by execution of a cloud application.

If removal of the security key device 2, namely, a disconnection is detected during the automatic encoding operation in step S250, the agent releases the automatic encoding and removes the files in the corresponding folder, thereby preventing synchronization with the cloud server 3.

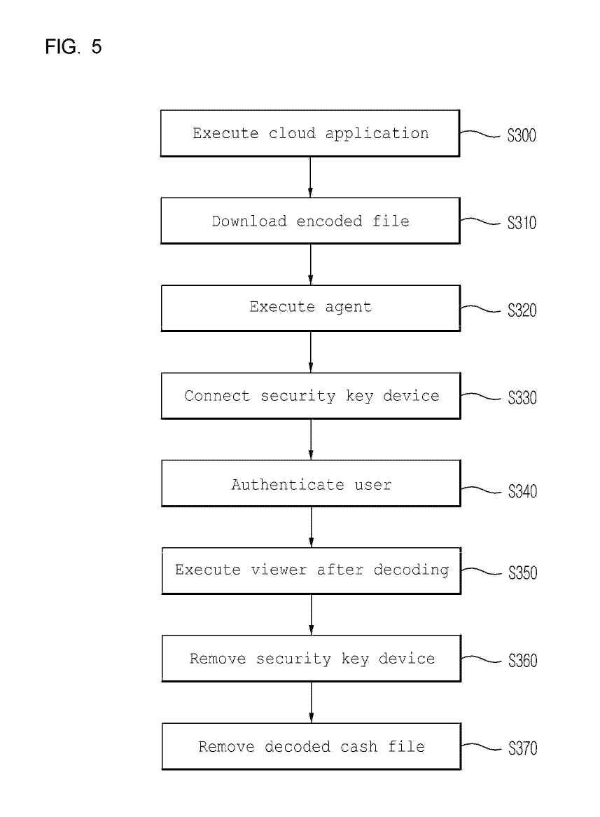

FIG. 5 is a flowchart illustrating a process of opening a file by using a cloud service in a mobile environment.

A cloud application that provides a cloud service is executed in step S300, and an encoded file is downloaded from a cloud server 3 to a mobile terminal in step S310.

When the encoded file is received, an agent for a secure cloud service is driven in step S320 to monitor a connection of a security key device 2.

When the security key device 2 is connected to the mobile terminal in step S330, user authentication is performed in step S340. When the user authentication is completed, the agent transmits the received encoded file to the security key device 2 such that the encoded file is decoded to the original file, and then executes a viewer program for opening the corresponding file to display the decoded file on a screen, in step S350.

If removal of the security key device 2, namely, a disconnection is detected during the file download operation in step S360, the agent releases the automatic decoding and removes decoded cache files in the corresponding folder, thereby preventing execution of the corresponding file in step S370.

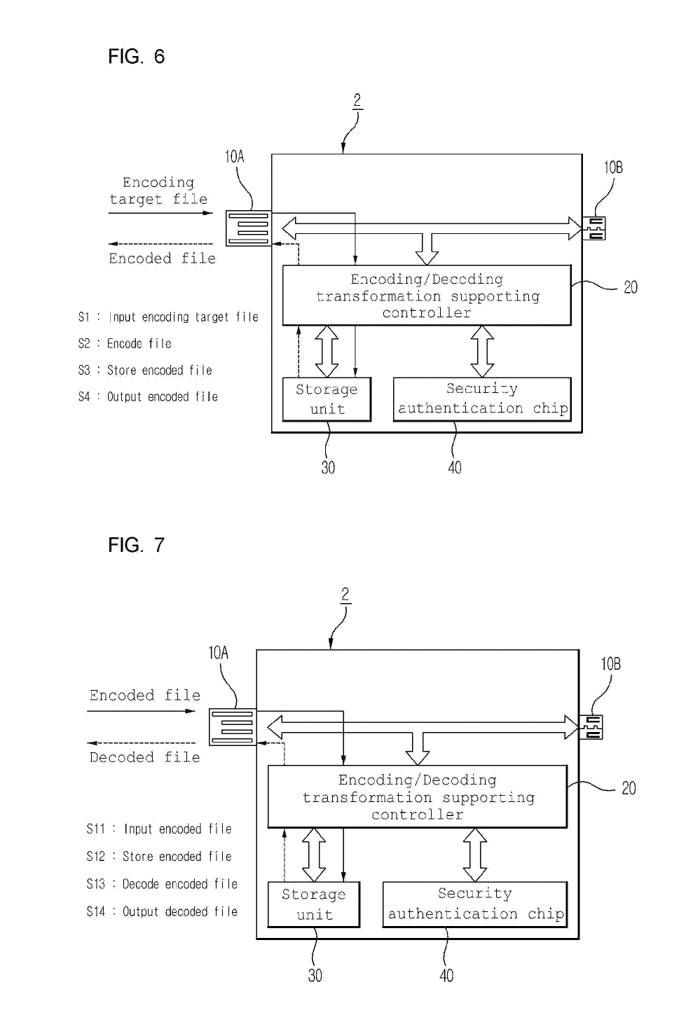

FIG. 6 illustrates a process of encoding a file in a security key device during a file upload, and FIG. 7 illustrates a process of decoding a file in a security key device during a file download. In FIGS. 6 and 7, a case in which a user terminal 1 is connected to a USB connector 10A is illustrated.

First, referring to FIG. 6, data flow from an agent to a security key 2 during a file upload is illustrated by a solid line, and data flow from the security key 2 to the agent is illustrated by a dotted line.

When an original file to upload is input from the agent (S1), an encoding/decoding transformation supporting controller 20 encodes the received original file (S2), stores the encoded file in a storage unit 30 (S3), and then transfers the encoded file, stored in the storage unit 30, to the agent (S4).

Next, referring to FIG. 7, data flow from the agent to the security key 2 during a file download is illustrated by a solid line, and data flow from the security key 2 to the agent is illustrated by a dotted line.

When an encoded file downloaded from a cloud server 3 is input from the agent (S11), the encoding/decoding transformation supporting controller 20 passes through the received encoded file to store the same in the storage unit 30 (S12), decodes the encoded file stored in the storage unit 30 (S13), and then transfers the decoded file to the agent (S14).

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A security key device for a secure cloud service, comprising:
an interface unit detachably connected to a user terminal, and providing an interface with the user terminal;
a storage unit storing an encoded user file; and
an encoding/decoding transformation supporting controller that, when receiving from the user terminal a file to upload to a cloud server, encodes the file, stores the encoded file in the storage unit, and then transmits the encoded file to the user terminal, and when receiving from the user terminal an encoded file downloaded from the cloud server, stores the encoded file in the storage unit, decodes the encoded file, and transmits the decoded file to the user terminal.

2. The security key device as claimed in claim 1, wherein the storage unit is distinguished into an ordinary data storage area and an encoded file storage area.

3. The security key device as claimed in claim 1, further comprising:
a security authentication chip comprising at least one of password information, a user's fingerprint information, and an OTP value for user authentication,
wherein the encoding/decoding transformation supporting controller operates only when the user authentication is performed through the security authentication chip.

4. A system for providing a secure cloud service which shares a user's file through a cloud service, the system comprising:
a cloud server providing the cloud service for sharing the user's file;
a user terminal in which an agent providing the secure cloud service is installed; and
a security key device that operates while being detachably connected to the user terminal, when receiving from the agent a file to upload to the cloud server, encodes the file to transmit the encoded file to the agent, and when receiving from the agent an encoded file downloaded from the cloud server, decodes the encoded file to transmit the decoded file to the user terminal.

5. The system as claimed in claim 4, wherein the agent generates a secure synchronous folder for secure cloud synchronization, transmits a specific file within the user terminal to the security key device when the specific file is transferred to the secure synchronous folder, and when receiving an encoded file from the security key device, transmits the encoded file to the cloud server.

6. The system as claimed in claim 5, wherein the agent generates the secure synchronous folder as a subfolder of a synchronous folder for cloud synchronization, monitors file input/output of the secure synchronous folder in real time, and when a file is transferred to the secure synchronous folder, encodes the file through the security key device to store the encoded file in the secure synchronous folder.

7. A method of providing a cloud service by an agent installed in a user terminal, the method comprising:
detecting a connection of a security key device;
performing user authentication processing when the connection of the security key device is detected;
transmitting a specific file within the user terminal to the security key device when the specific file is transferred to a cloud encoding synchronous folder;
storing an encoded file in the cloud encoding synchronous folder when the encoded file is received from the security key device; and
transmitting the encoded file stored in the cloud encoding synchronous folder to a cloud server through cloud synchronization.

8. The method as claimed in claim 7, further comprising:
transmitting an encoded file to the security key device when receiving the encoded file from the cloud server;
receiving a decoded file from the security key device; and
storing the decoded file in the cloud encoding synchronous folder.

9. The method as claimed in claim 8, further comprising:
releasing automatic encoding and deleting a decoded temporary file, when a disconnection of the security key device is detected.

10. The method as claimed in claim 7, wherein the agent generates a secure synchronous folder as a subfolder of the cloud encoding synchronous folder, and performs encoding through the security key device only for a file transferred to the secure synchronous folder.
